(19) United States
(12) Patent Application Publication
(10) Pub. No.: US 2019/0260671 A1
(43) Pub. Date: Aug. 22, 2019

(54) Ethernet protection systems and methods with fast traffic recovery eliminating flooding, learning, and flushing

(71) Applicant: Ciena Corporation, Hanover, MD (US)

(72) Inventors: Ross Caird, Kanata (CA); Yang Sup Lee, Nepean (CA)

(21) Appl. No.: 15/900,239

(22) Filed: Feb. 20, 2018

(51) Int. Cl. H04L 12/703; H04L 12/24; H04L 12/721; H04L 12/751

(52) U.S. Cl. CPC H04L 45/28; H04L 45/02; H04L 45/66; H04L 41/0654

(57) ABSTRACT

Systems and methods for Ethernet forwarding based on inferring topology in a G.8032 ring via control frames, implemented in a network element, include monitoring received control frames; determining which line port on the network element in the G.8032 ring is active based on the received control frames such that the topology of the G.8032 ring is inferred based on the received control frames; and forwarding data frames on the determined line port. The systems and methods can further include, subsequent to a fault and associated G.8032 protection which modifies ring blocks in the G.8032 ring, determining a change in the topology based on the received control frames; and updating the forwarding of the data frames based on the change.

### FIELD OF THE DISCLOSURE

The present disclosure generally relates to Ethernet networking systems and methods. More particularly, the present disclosure relates to Ethernet protection systems and methods with fast traffic recovery which eliminates the reliance on flooding, Media Access Control (MAC) address learning, and MAC address flushing.

### BACKGROUND OF THE DISCLOSURE

Ethernet Ring Protection Switching (ERPS) is defined in ITU-T G.8032 (08/2015), the contents of which are incorporated by reference, provides sub-50 ms protection and recovery switching for Ethernet traffic in a ring topology and at the same time ensures that there are no loops formed at the Ethernet layer. G.8032v1 supported a single ring topology, and G.8032v2 supports multiple rings/ladder topology. ITU-T G.8032 is often used to provide Ethernet Ring Protection in conjunction with Ethernet Private Line (EPL) or Ethernet Private Local Area Network (EPLAN) service models both employing MAC learning and forwarding via Forwarding Databases (FDB). EPL and EPLAN are defined in MEF 6.1 “Ethernet Services Definitions—Phase 2,” (04/2008), the contents of which are incorporated by reference. An EPL service uses a Point-to-Point Ethernet Virtual Circuit (EVC) between two User-Network Interfaces (UNIs) and provides a high degree of transparency for Service Frames between the UNIs it interconnects such that the Service Frame's header and payload are identical at both the source and destination UNI when a Service Frame is delivered. Similar to EPL, an EPLAN service is a Multipoint-to-Multipoint EVC between multiple UNIs.

Typically, services residing on G.8032 rings, rely on the use of the FDB in order to make forwarding decisions and this requires fast flushing, fast learning, and flooding at a line rate, in order to achieve optimal performance. Of course, all Ethernet switches are not created equal, some support flooding at line rate, and some do not. Some Ethernet switches support a fast flushing capability, and some do not. Some Ethernet switches support hardware MAC learning, and some require software support for MAC learning. As a result, performance can vary for G.8032 protection and, in some cases, the performance can prevent using the switch hardware (e.g., Application Specific Integrated Circuit (ASIC)) for G.8032 protection due to the extended disruption time during protection switching.

### BRIEF SUMMARY OF THE DISCLOSURE

In an embodiment, a method for Ethernet forwarding based on inferring topology in a G.8032 ring via control frames, implemented in a network element, includes monitoring received control frames; determining which line port on the network element in the G.8032 ring is active based on the received control frames such that the topology of the G.8032 ring is inferred based on the received control frames; and forwarding data frames on the determined line port. The method can further include, subsequent to a fault and associated G.8032 protection which modifies ring blocks in the G.8032 ring, determining a change in the topology based on the received control frames; and updating the forwarding of the data frames based on the change. The determining can be based on detecting transformations of the received control frames. The transformations can include adjustments to one or more of Priority Code Point (PCP) and Drop Eligible Indicator (DEI) values in the control frame. The transformations can include detection of a Virtual Local Area Network (VLAN) tag. The received control frames can be multicast by terminal network elements in the G.8032 ring and prevented from a loop in the G.8032 based on a ring block. The network element can be configured to not perform Media Access Control (MAC) learning and flooding for forwarding decisions. The G.8032 ring can provide Ethernet Ring Protection in conjunction with one of an Ethernet Private Line (EPL) service and an Ethernet Private Local Area Network (EPLAN) service. The control frames can be sent at an interval of 10 ms or less.

In another embodiment, an apparatus configured for Ethernet forwarding based on inferring topology in a G.8032 ring via control frames, implemented in a network element, includes circuitry configured to monitor received control frames; circuitry configured to determine which line port on the network element in the G.8032 ring is active based on the received control frames such that the topology of the G.8032 ring is inferred based on the received control frames; and circuitry configured to forward data frames on the determined line port. The apparatus can further include circuitry configured to determine a change in the topology based on the received control frames subsequent to a fault and associated G.8032 protection which modifies ring blocks in the G.8032 ring, wherein the circuitry configured to forward data frames is updated based on the change. The circuitry configured to determine can detect transformations of the received control frames. The transformations can include adjustments to one or more of Priority Code Point (PCP) and Drop Eligible Indicator (DEI) values in the control frame. The transformations can include detection of a Virtual Local Area Network (VLAN) tag. The received control frames can be multicast by terminal network elements in the G.8032 ring and prevented from a loop in the G.8032 based on a ring block. The network element can be configured to not perform Media Access Control (MAC) learning and flooding for forwarding decisions. The G.8032 ring can provide Ethernet Ring Protection in conjunction with one of an Ethernet Private Line (EPL) service and an Ethernet Private Local Area Network (EPLAN) service. The control frames can be sent at an interval of 10 ms or less.

In a further embodiment, a network element configured for Ethernet forwarding based on inferring topology in a G.8032 ring via control frames includes a plurality of ports and switching circuitry configured to switch frames between the plurality of ports; and a controller communicatively coupled to the plurality of ports and the switching circuitry, wherein the controller is configured to monitor received control frames, determine which line port on the network element in the G.8032 ring is active based on the received control frames such that the topology of the G.8032 ring is inferred based on the received control frames, and cause the data frames to be forwarded on the determined line port. The controller can be further configured to determine a change in the topology based on the received control frames subsequent to a fault and associated G.8032 protection which modifies ring blocks in the G.8032 ring, and cause the data frames to be forwarded based on the change.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of a network of network elements illustrating existing behavior in G.8032 prior to MAC learning;

FIG. 2 is a network diagram of the network of FIG. 1 illustrating existing behavior in G.8032 subsequent to MAC learning;

FIG. 3 is a network diagram of the network of FIGS. 1-2 illustrating existing behavior in G.8032 subsequent to a fault;

FIG. 4 is a network diagram of the network of FIGS. 13 illustrating existing behavior in G.8032 subsequent to a fault with MAC flooding;

FIG. 5 is a network diagram of the network of FIGS. 1-4 illustrating existing behavior in G.8032 subsequent to the MAC flooding;

FIG. 6 is a network diagram of a network of network elements A-E with an Ethernet Private Line (EPL) service between switches and associated control traffic originating from the network element E;

FIG. 7 is a network diagram of the network of FIG. 6 and associated data traffic originating at the network element A;

FIG. 8 is a network diagram of the network of FIGS. 6-7 and associated control traffic originating from the network element A;

FIG. 9 is a network diagram of the network of FIGS. 6-8 and associated data traffic originating at the network element E;

FIG. 10 is a network diagram of the network of FIGS. 6-9 illustrating a fault between the network elements B, C and associated control traffic originating at the network element E;

FIG. 11 is a network diagram of the network of FIGS. 6-10 illustrating associated data traffic from the network element A subsequent to the fault;

FIG. 12 is a network diagram of the network of FIGS. 6-11 illustrating associated control traffic originating at the network element A subsequent to the fault;

FIG. 13 is a network diagram of the network of FIGS. 6-12 illustrating associated data traffic from the network element E subsequent to the fault;

FIG. 14 is a network diagram of the network of FIGS. 6-13 and associated control traffic subsequent to the fault being cleared;

FIG. 15 is a network diagram of the network of FIGS. 6-14 and associated data traffic subsequent to the fault being cleared;

FIG. 16 is a network diagram of a network in a misconfiguration scenario;

FIG. 17 is a network diagram of a network illustrating 1+1 Ethernet Line Protection utilizing the systems and methods;

FIG. 18 is a flowchart of a process for Ethernet forwarding based on inferring topology in a G.8032 ring via control frames; and

FIG. 19 is a block diagram of an example network element for the systems and methods described herein.

### DETAILED DESCRIPTION OF THE DISCLOSURE

In various embodiments, the present disclosure relates to Ethernet protection systems and methods with fast traffic recovery which eliminates the reliance on flooding, Media Access Control (MAC) address learning, and MAC address flushing. The systems and methods dynamically adjust the forwarding behavior of EPL services based on automatically inferring the desired egress forwarding direction (East or West) based on the knowledge of which port (East or West) ingress received control frames are detected, which are arriving from a remote service terminating node. The systems and methods infer the direction around a G.8032 blocked ring based on the knowledge of the source port for the received “sideband” control frames. The systems and methods are used in conjunction with G.8032 rings but work in parallel. The systems and methods allow fast traffic recovery without relying on the performance capabilities of an Ethernet switch ASIC flooding (bandwidth), MAC address learning rate, and fast MAC address flushing rate. Stated differently, the systems and methods evaluate and detect transformations of frames, such as control frames, to identify and select the network topology which is used for data forwarding in lieu of MAC learning, flooding, and flushing.

The systems and methods involve the use of control frames which are transmitted and flooded out to both ring “line” ports, from network elements where Ethernet Private Line (EPL) services terminate. The systems and methods can use packet modifications on “line” port ingress in order to “mark” or “indicate” which “line” port the control frames are currently being received on, in order to make modifications to the “line” egress (customer) data path when the network data path changes as a result of protection switches or reversions. The active forwarding path is determined by dynamic forwarding rules which are modified instead of FDB flushing, flooding and learning, in order to forward the traffic from a “client” port to one particular “line” port (the same port and only port where the control frames are being received). Forwarding rules will govern the flow of traffic (point to point—from UNI port to Network-Network Interface (NNI) port), in order to follow the desired path, which is derived from the control frame traffic “ingressing” only one of the “line” ports. The systems and methods can use either specific source port information in proprietary “pushed” headers (which can be prepended to the control frames on reception) or modifications to specific fields within the control frames Virtual Local Area Network (VLAN) tag (such as but not limited to Priority Code Point (PCP) or Drop Eligible Indicator (DEI)). The systems and methods can provide fast traffic switching without relying on the FDB of the switch to make forwarding decisions based on MAC addresses.

The systems and methods may also be used where EPL services are forwarded using different encapsulation methods such as VLAN tagging or Forwarding Equivalence Class (FEC), in the case of Multiprotocol Label Switching (MPLS). The systems and methods are described herein with reference to a single chassis or single blade implementation, but the systems and methods may also be used in a chassis-based architecture where switching decisions are made via a central switch fabric.

Again, Ethernet Ring Protection schemes rely on the FDBs within the Ethernet Switches, residing in network elements, in order to learn the desired active forwarding path for customer traffic. This places reliance on the performance of the Ethernet switch and possibly the associated software for flushing (cleaning out entries in the FDB) and for learning (adding entries to the FDB). It also places reliance on the flooding performance (forwarding to all member ports in a VLAN when the MAC Destination Address (DA) of a frame is not known within the FDB—in frames per second) of the Ethernet switch. The systems and methods do not rely on these performance characteristics. When learning and flushing are involved, performance can vary based on the number of MAC addresses required to be learned or flushed. The systems and methods also provide consistent performance regardless of the number of MAC source addresses within the customer traffic flows. The systems and methods have no dependence on the size of an Ethernet switches FDB.

### Existing G.8032 Behavior

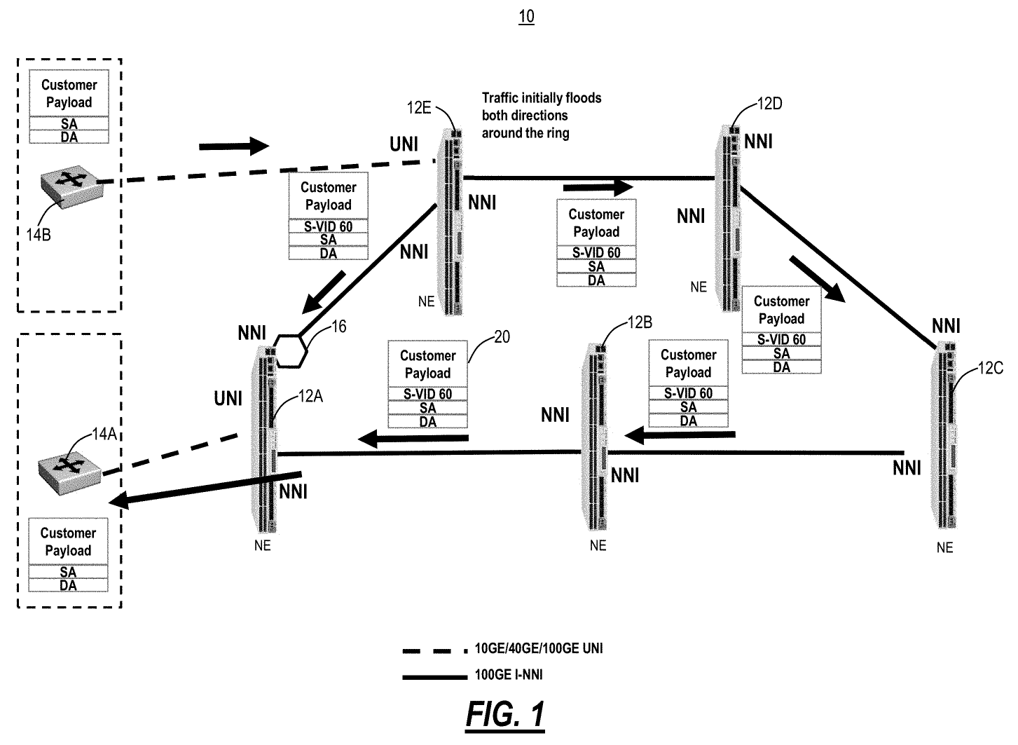

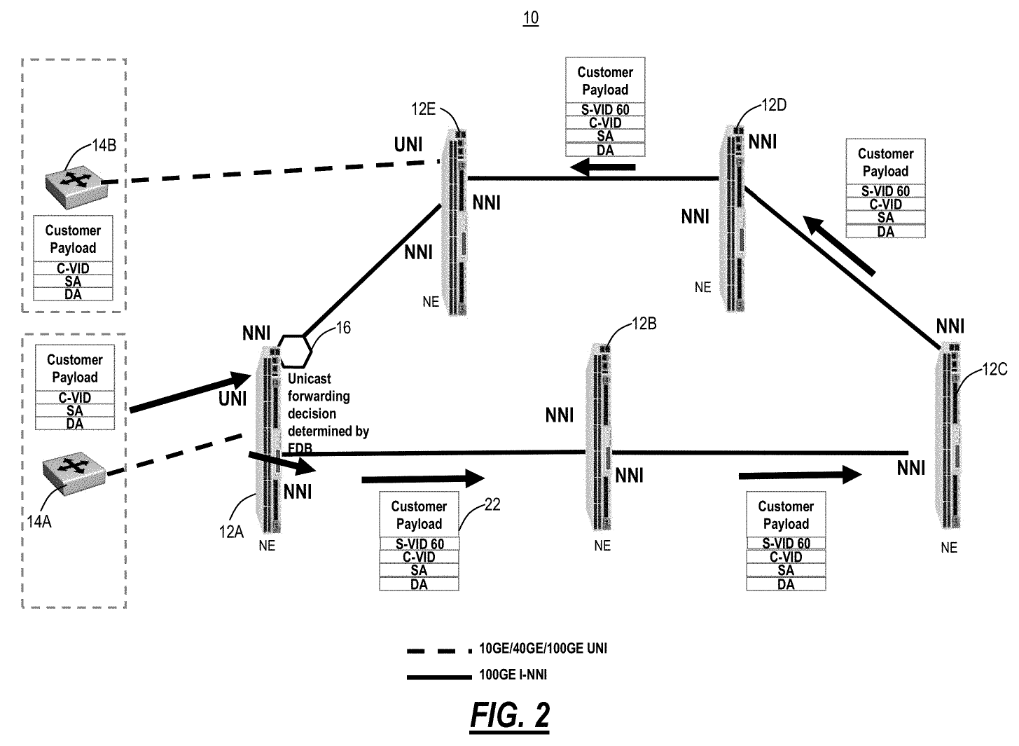

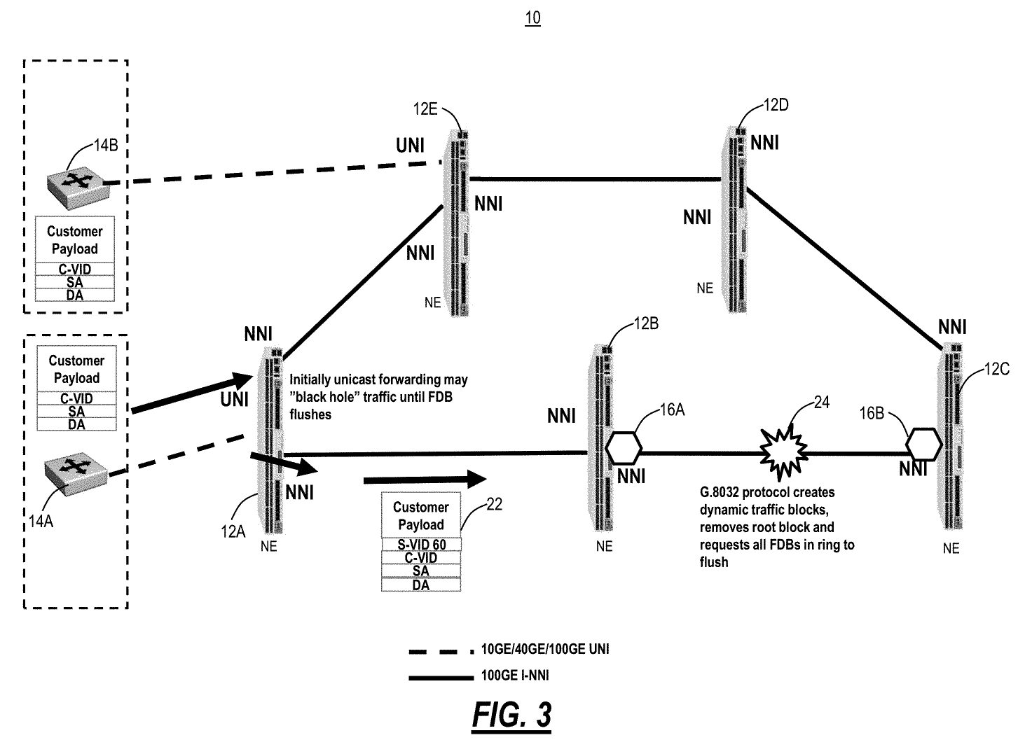

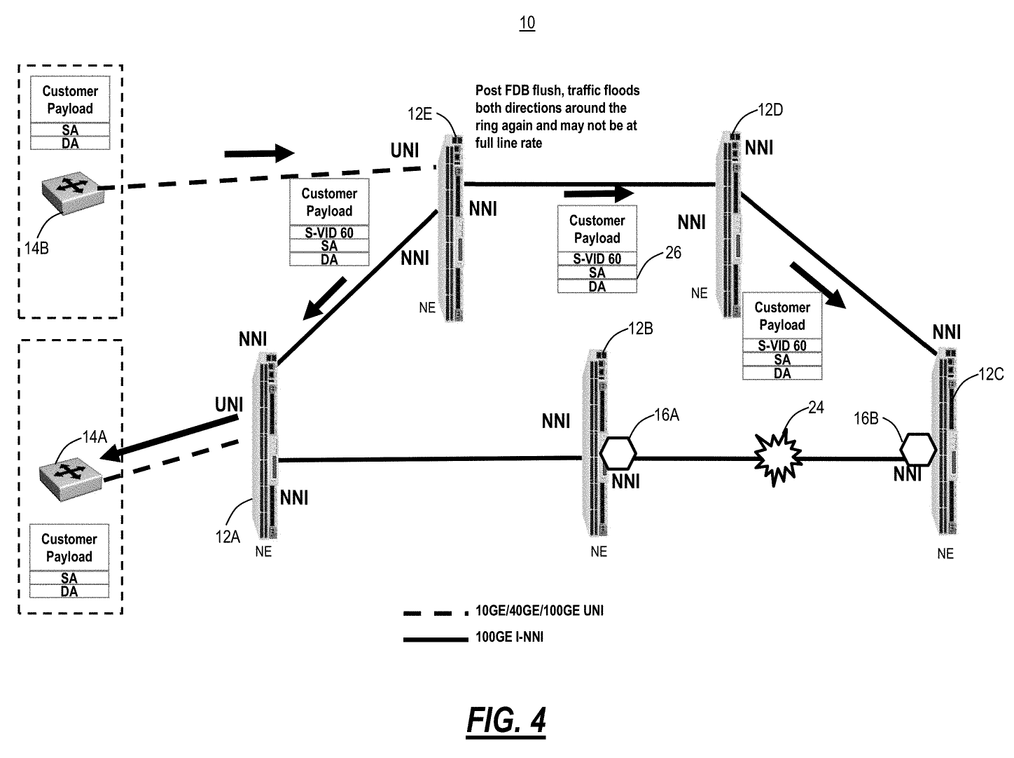

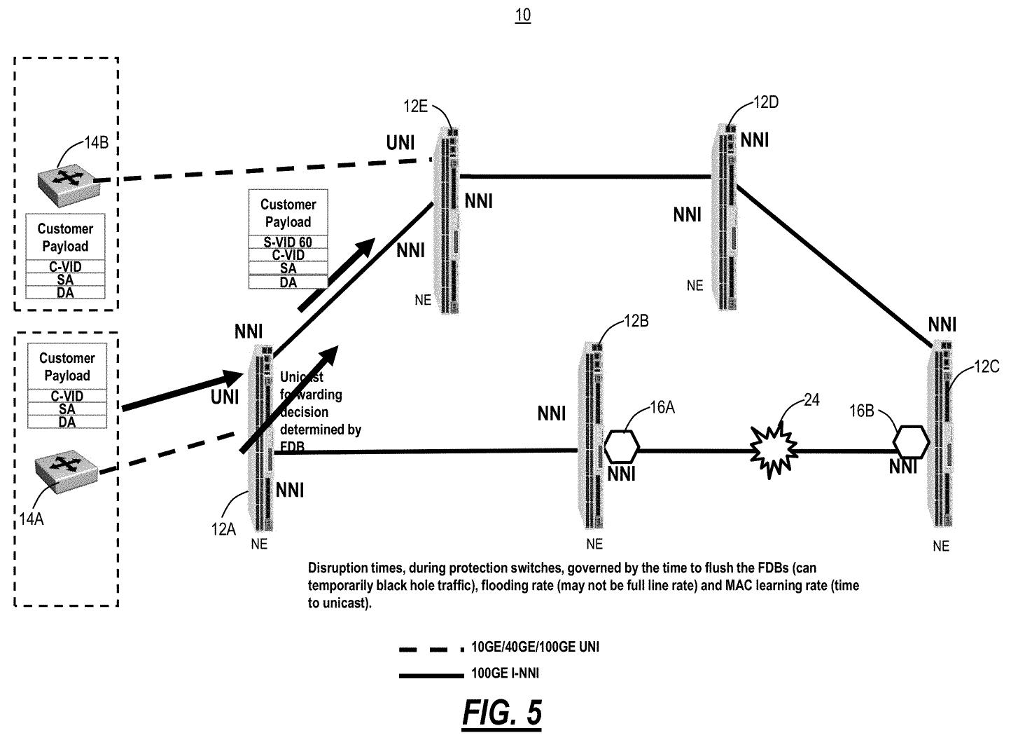

FIG. 1 is a network diagram of a network 10 of network elements 12A-12E illustrating existing behavior in G.8032 prior to MAC learning. FIG. 2 is a network diagram of the network 10 illustrating existing behavior in G.8032 subsequent to MAC learning. FIG. 3 is a network diagram of the network 10 illustrating existing behavior in G.8032 subsequent to a fault. FIG. 4 is a network diagram of the network 10 illustrating existing behavior in G.8032 subsequent to a fault with MAC flooding. FIG. 5 is a network diagram of the network 10 illustrating existing behavior in G.8032 subsequent to the MAC flooding.

The network elements 12A-12E are configured in a G.8032 ring and, in this example, interconnected customer premise switches 14A, 14B to one another. The G.8032 has a ring block 16 on an NNI port of the network element 12A. The switch 14A has a UNI port connected to the network element 12A, and the switch 14B has a UNI port connected to the network element 12E. The network elements 12A-12E each include East and West NNI ports in the G.8032 ring (note, East and West are used to logically separate each NNI port on each network element 12). In this example, the UNI ports on the switches 14A, 14B are configured to communicate frames with customer payload, a Service Virtual Local Area Network ID (C-VID), a Source Address (SA), and a Destination Address (DA) to one another via the network elements 12A-12E over the G.8032 ring. For example, assume the C-VID is 60. Also, in this example, connectivity can include 10 Gigabit Ethernet (GE)/40 GE/100 GE UNI links such as between the switches 14A, 14B and the network elements 12A-12E, respectively, and 100GE Internal NNI (I-NNI) links between the network elements 12A-12E.

In FIG. 1, the switch 14B is illustrated initially transmitting frames 20 to the network element 12E destined for the switch 14A via the network element 12A. The network element 12E initially floods the frames in both directions around the G.8032 ring for MAC learning. Also, in FIG. 1, the ring block 16 at the network element 12A is used to prevent traffic loops in the G.8032 ring. Of note, in this example, the ring block 16 is shown at the network element 12A which is a service terminating node. Those skilled in the art recognize in G.8032 the ring block 16 could be at any of the network elements 12. For example, the G.8032 ring could work if the ring block 16 was on either the East or West port of the network element 12D which is not a service terminating node. Also, other Ethernet services including EPL can be deployed and coexist on the network elements 12 and the systems and methods described herein are implemented on a per service basis at each service's terminating network elements.

In FIG. 2, after MAC learning forwarding decisions determined by a Forwarding Database (FDB) at each network element 12. For example, in FIG. 2, the switch 14A is shown sending frames 22 via the network element 12A destined for the switch 14B via the network element 12E. The network element 12A makes a unicast forwarding decision based on its FDB for the DA of the switch 14B.

In FIG. 3, a fault 24 occurs between the network elements 12B, 12C, FIG. 3 continues from FIG. 2 where forwarding decisions are determined by the FDB, and the network element 12A sends the frames 22 to the network element 12E towards the fault 24. As the fault 24 occurs, the traffic initially “black holes” and is lost at the fault 24, until the FDBs are flushed. After the fault 24, G.8032 creates dynamic ring blocks 16A, 16B adjacent to the fault 24 while removing the ring block 16 (see FIG. 2) on the network element 12A and requesting all FDBs in the G.8032 ring to be flushed. Here, the FDBs drop all previously learned MAC addresses and the network reverts to relearning as MAC address flooding occurs.

For the illustrated example for the EPL service between network elements 12A and 12E, the flushing, flooding and learning is reduced even at the intermediate network element 12D. Without the systems and methods, the performance of intermediate node 12D would impact the EPL service of the illustrated example. With the systems and methods, less than full rate MAC address flooding and learning can be tolerated to the benefit of all customers regardless whether the customers are connected to full rate MAC address flooding and learning network elements 12. Note, the systems and methods avoid use of the FDB for forwarding decisions. Instead, a local indicator or data structure can be managed for the current forwarding direction for each service and the contents could be altered whenever a network reconfiguration is detected and the data path is altered as a result.

In FIG. 4, after the FDBs are flushed in FIG. 3, the network elements 12A, 12E flood traffic in both directions around the G.8032 ring for new MAC learning while blocks 16A, 16B are in place and this may not proceed at a full line rate. For example, FIG. 4 illustrates the switch 14B transmitting frames 26 to the switch 14A via the network elements 12E, 12A. Traffic disruption time is governed by the time it takes to flush the FDB at each network element 12 and the bandwidth capability during flooding and the rate at which each node FDB can learn MAC addresses. If flooding is possible at a full line rate in the G.8032 ring, then disruption is governed by detection speed and flushing time only. If flooding at line rate is not possible, then disruption is also governed by learning duration. In FIG. 5, after the MAC learning in FIG. 4 due to the network topology change, the forwarding decisions are determined by the FDBs in each node 12. Again, the disruption time is governed by the time it takes to flush the FDB at each network element 12 and the bandwidth capability during flooding and the rate at which each FDB can learn MAC addresses.

### Ethernet Forwarding Based on Inferred Topology

The systems and methods proposed herein dynamically adjust the forwarding behavior of EPL services based on the inferred topology which is based on detecting control frames. This is used in place of MAC learning, flooding, and flushing. The systems and methods utilize existing G.8032 for loop prevention and protection switching. Further, terminal network elements such as the network elements 12A, 12E utilize existing multicast control frames to convey link state forwarding information. The systems and methods determine a transformation applied to the control frames to determine forwarding decisions dynamically. That is, the systems and methods forward traffic based on the inferred topology from the control frames instead of learning, flooding, and flushing of the FDB. The control frames use same unique service identifiers (e.g., VLAN ID). The transformations (or lack thereof) at terminating network elements (e.g., the network elements 12A, 12E) indicate desired direction for traffic forwarding.

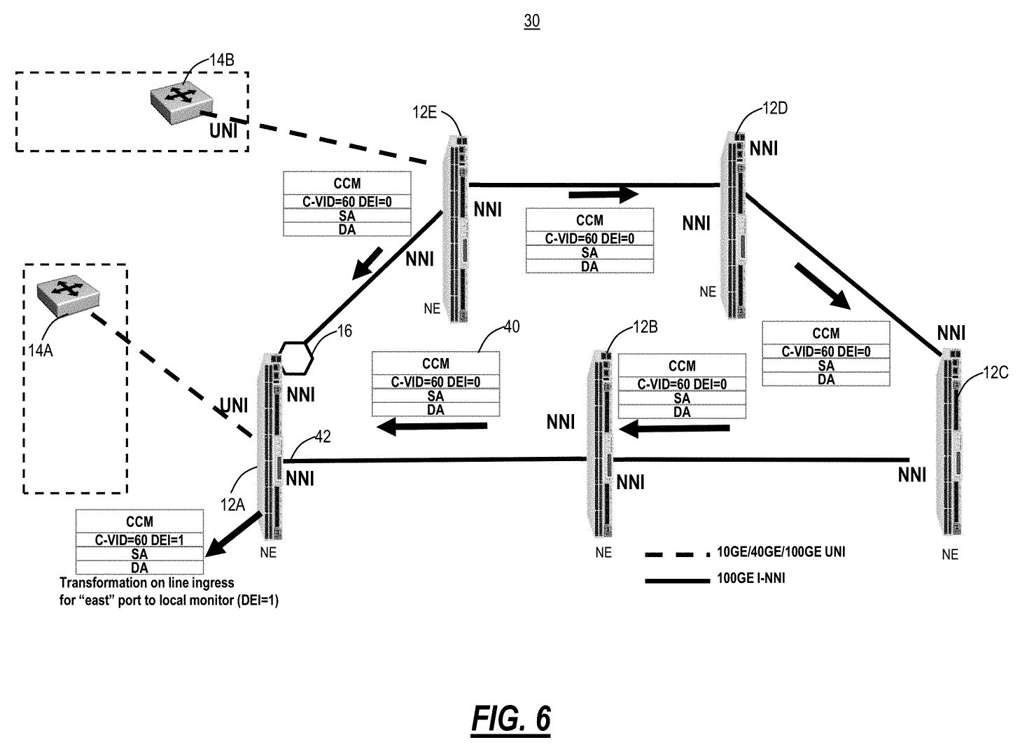

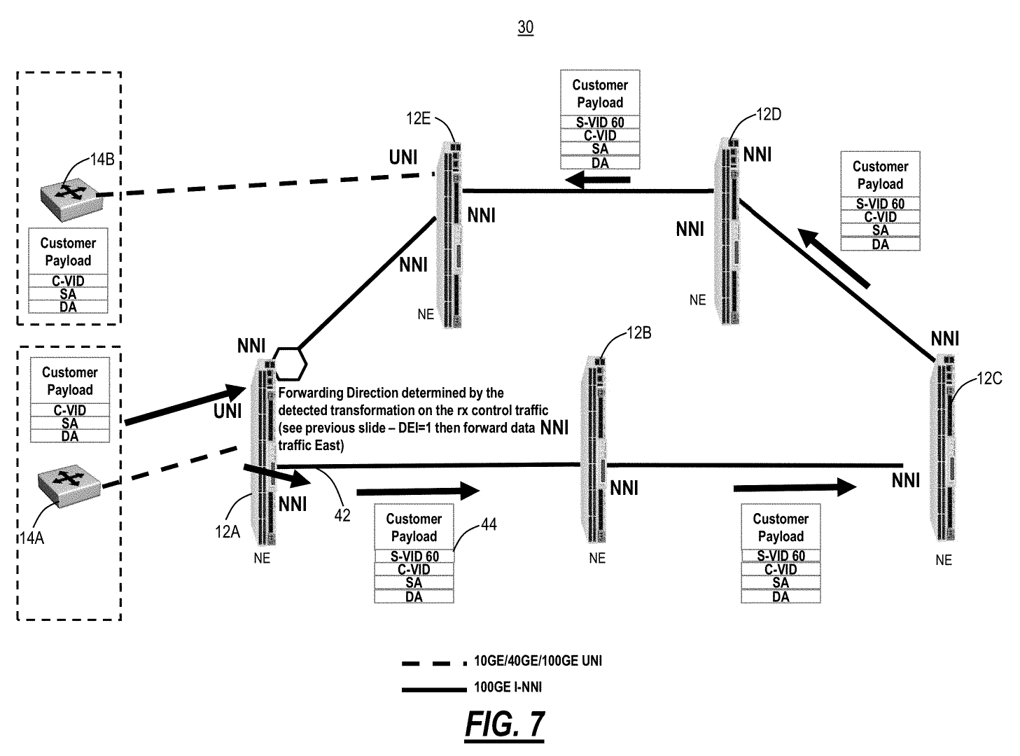

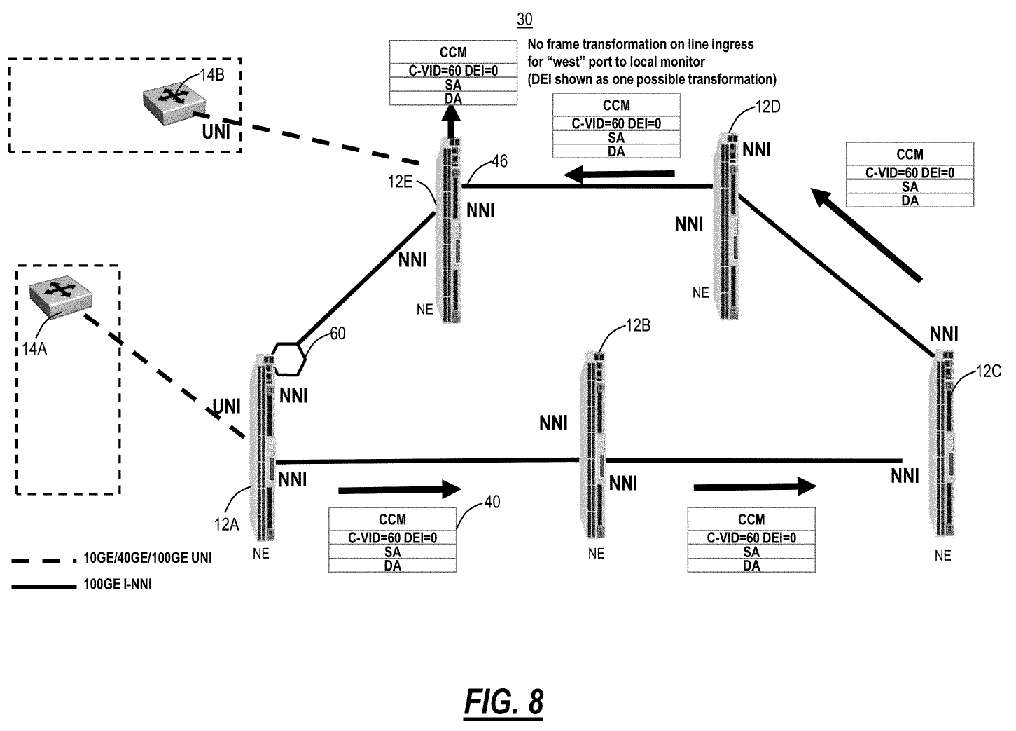

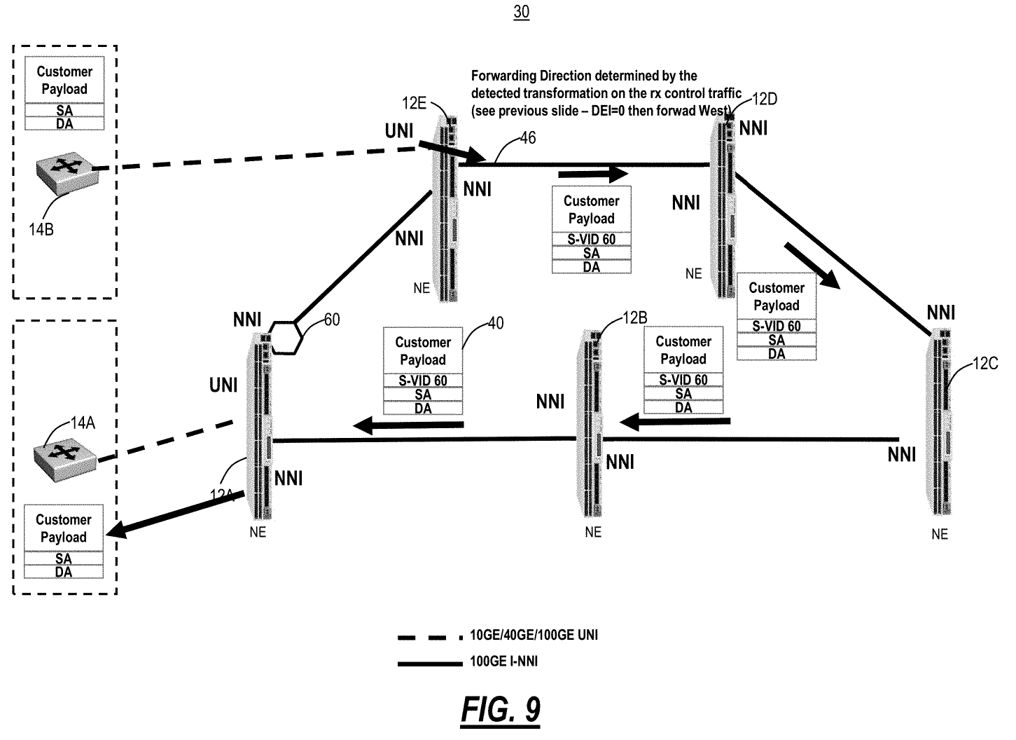

FIG. 6 is a network diagram of a network 30 of network elements 12A-12E with an Ethernet Private Line (EPL) service between switches 14A, 14B, and associated control traffic originating from the network element 12E. FIG. 7 is a network diagram of the network 30 and associated data traffic originating at the network element 12A. FIG. 8 is a network diagram of the network 30 and associated control traffic originating from the network element 12A. FIG. 9 is a network diagram of the network 30 and associated data traffic originating at the network element 12E.

Specifically, the network elements 12A-12E in the network 30 are configured in a G.8032 ring with a ring block 16 on an NNI port of the network element 12A. The switch 14A has a UNI port connected to the network element 12A, and the switch 14B has a UNI port connected to the network element 12 E. The network elements 12A-12E each include East and West NNI ports in the G.8032 ring. In this example, the UNI ports on the switches 14A, 14B are configured to communicate frames with payload, a Customer Virtual Local Area Network ID (C-VID), a Source Address (SA), and a Destination Address (DA) to one another via the network elements 12A-12E. For example, assume the C-VID is 60. Also, in this example, connectivity can include 10 Gigabit Ethernet (GE)/40GE/100GE UNI links such as between the switches 14A, 14B and the network elements 12A, 12E, respectively, and 100GE Internal NNI (I-NNI) links between the network elements 12A-12E.

Control frames such as Continuity Check Messages (CCMs) are typically used to convey link state forwarding behavior and G.8032 with the ring block 16 is employed for loop prevention and protection switching. The systems and methods recognize transformations applied to multicast control frames 40 can be used to deduce the current topology and drive dynamic forwarding decisions. In this example, the network elements 12A, 12E source and sink multicast control frames 40. The network element 12A sends the control frames 40 (e.g., CCMs) in both directions to 12B, 12C, 12D, 12E (the G.8032 RPL blocks traffic in one direction though). The network element 12E is unaware of the ring block 16, and thus there can be no frame transformation on the line ingress for the West port (due to the absence of incoming control frames). For example, a possible frame transformation is changing the DEI based on where the control frame is received (i.e., on the East or West port). The network element 12E sends the control frames 40 (e.g., CCMs) in both directions to the network elements 12D, 12C, 12B, 12A. The network element 12A is aware of the ring block 16 (but no control frames 40 arrive on the line port facing the ring block 16) and can transform the control frame 40 such as to change DEI to 1.

In an embodiment, the control frames 40 can be CCMs which are sent periodically at regular intervals. The regular intervals can be:

3.33 ms: default transmission period for protection switching application
(transmission rate of 300 frames/second)
10 ms: (transmission rate is 100 frames/second)
100 ms: default transmission period for performance monitoring
application (transmission rate of 10 frames/second)
1 s: default transmission period for fault management application
(transmission rate of 1 frame/second)
10 s: (transmission rate of 6 frames/minute)
1 min: (transmission rate of 1 frame/minute)
10 min: (transmission rate of 6 frames/hour)

The control frame 40 interval can be set at 3.3 ms or 10 ms such that the interval is fast-enough for the network element 12 to detect a change and switch within a reasonable time period such as sub-50 ms.

The systems and methods evaluate and detect transformations of the multicast control frames to identify the network topology which is used for data forwarding in lieu of MAC learning, flooding, and flushing. As described herein, transformation is another name for modification of frames. The transformation can be anything which can be used to infer the network topology, i.e., the location of the ring block 16. In an example application, frames are marked as “discard eligible” by changing the DEI bit based on where the control frame was received from. This DEI transformation rule which is used herein for illustration can be described as follows:

If the frame arrived on the west NNI port, the DEI value in the frame would be remarked to 0; and

If the frame arrived on the east NNI port, the DEI value in the frame would be remarked to 1.

This DEI transformation rule is only performed at a terminal node, i.e., where the control frames 40 are terminated with respect to the EPL service. In the example of FIGS. 6-9, this includes the network elements 12A, 12E. The other network elements 12B, 12C, 12D are called tandem nodes which simply pass the control frames transparently as well as data frames (e.g., similar to a regenerator). In FIG. 6, the ring block 16 will be blocking frames around the ring such that control frames 40 will only be received from one side (ingress of one and only one line port) on the network element 12A, the control frames 40 are received on an East NNI port 42 and the DEI bit is transformed from 0 to 1 based on the DEI transformation rule.

In FIG. 6, the DEI bit can be used to indicate which line port is active at the network element 12A. In general, the DEI transformation rule marks the control frames 40 coming in from the East as one way and coming in from the West as the other. In this example, the network element 12A only receives the control frames 40 on the East NNI port 42. The network element 12A can infer the right direction to send the traffic by knowing which line port was receiving control frames from the other terminal network element 12E.

Of course, if the ring block 16 moves, the network elements 12A, 12E can see a change in which directions they receive the control frames 40, e.g., based on the transformation. In this manner, the network elements 12A, 12E can change their forwarding accordingly to match the new topology which is inferred from the control frames 40.

Frame transformation is a technique to determine what happens to the control frames 40 which can be used to infer the network topology. Frames are always transformed at the terminal network elements (the network elements 12A, 12E), but the transformation only occurs on one line port and not the other. Concurrently, G.8032 controls the ring block 16. The ring block 16 prevents traffic from looping. When there is a break in the G.8032 ring, then dynamic blocks are placed adjacent to the break, and the root block is removed in order for traffic to flow. The systems and methods do not change the behavior of G.8032, but rather work in parallel.

The DEI frame transformation is just one technique for frame transformation/modification based on the topology. Other techniques for frame transformation/modification are also contemplated to infer the topology. As another example, the frames Class of Service (CoS) priority (p-bits) could be monitored within the VLAN tag. A further example can include an extra VLAN tag, and anything in the extra VLAN tag can be used.

The systems and methods can use the frame transformation/modification of the control frames 40 to determine the network topology. In another embodiment, the systems and methods can use other techniques such as notification of which port the control frames 40 are received on. For example, Ethernet switches such as the network elements 12 typically provide summary counts of frames received per port. The control frames 40 would be counted along with other customer traffic within the same counters. It would be possible on some switches to enable counters looking for particular frame characteristics, so it may be possible to count the received control frames 40 only with a “custom” counter but counters would provide a slow method of determining the information. Y.1731 CCMs for the control frames 40 are typically monitored for their “simple presence.” Their purpose is to determine end-to-end connectivity. A network element 12 typically provides fast notifications of loss of continuity (i.e., loss of RX CCMs) but can also notify if contents of the frames change too. This allows quick detection of modification and quick consequent action for use with the system and methods.

Another example of a transformation that could be used would be to modify the VLAN ID which is received coming in one line and not the other. The capability to detect loss of CCMs is commonly available in switches and can be used to monitor for loss of continuity for the flows of control frame 40 traffic by pushing a new VLAN tag onto the ingress frames (same flow of frames from the far end but the new pushed VLAN tag could have a unique VLAN ID to indicate one VLAN ID from the East and one VLAN ID from the West). If the VLAN ID was used as a transformation, then there would always have one active “loss of continuity” present for flows coming in one direction (but not for the other). If the flow of control frames arrived from East instead of West, then the East “loss of continuity” would clear and the West “loss of continuity” would raise. This “loss of continuity” could be detected quickly in the network element 12, as well of the “loss of continuity” clear condition. This transformation approach can be used to provide quick changes to network topology changes versus slow detection via counters (assuming custom programable counters are available in the hardware).

In FIG. 6, the network element 12A can determine that forwarding should be out the East NNI port 42. In FIG. 7, data frames 44 are shown originating from the network element 12A from the switch 14A destined for the switch 14 B via the network element 12E. At the network element 12A, forwarding decisions are determined by examining the transformations applied to the control frames 40 in FIG. 6. Traffic is forwarded from the “client” (the switch 14A) to either the East or West “line” port, based on the detected control frame 40 transformations. In this example, the network element 12A forwards the traffic out the East NNI port 42 based on the DEI transformation rule which detects the network element 12A changing the DEI bit from 0 to 1.

In FIG. 8, the control frames 40 are illustrated originating from the network element 12A. These control frames 40 are multicast out of the network element 12A but are not sent out the port on the network element 12A with the ring block 16 (due to the G.8032 ring protection feature running in parallel which is blocking the control frames 40). The network element 12E receives the control frames 40 on a West NNI port 46, and the DEI bit is transformed to 0 (or left alone since it was already set at 0). In FIG. 9, the data frames 40 are shown originating from the network element 12E from the switch 14B destined for the switch 14A via the network element 12A. At the network element 12E, the forwarding decision is determined based on the detected transformation on the control frames 40 from FIG. 8.

Thus, in this example based on the DEI transformation rule, the network element 12A can determine it receives the control frames 40 on the East NNI port 42 since the DEI bit is transformed to 1 and the network element 12E can determine it receives the control frames 40 on the West NNI port 46 since the DEI bit is transformed to 0 (or left alone). In this manner, the network elements 12A, 12E can dynamically determine the forwarding direction (where the control frames 40 were received) in lieu of using flooding, learning, and flushing.

The foregoing description utilizes control frames for monitoring to determine the topology. Those skilled in the art will recognize it could be any type of frame that is periodically sent, can uniquely identify a service, and is sent at a fast-enough interval to promptly detect changes. Control frames are an example—they are multicast, are unique to a service, and sent regularly at a fast-enough interval (e.g., 3.3 ms) to perform prompt detection of a state change. At a terminal network element 12, such as the network elements 12A, 12E, the network element 12 is configured to detect the presence of these unique frames (e.g., control frames) such as through circuitry which performs any of the transformation techniques described herein. At a sink location, i.e., a terminal network element 12 receiving the frames, the network element 12 is configured to continuously monitor for the presence of these frames to determine the active line and to cause a fast switch responsive to a change in the active line.

### Ethernet Forwarding Based on Inferred Topology—Fault

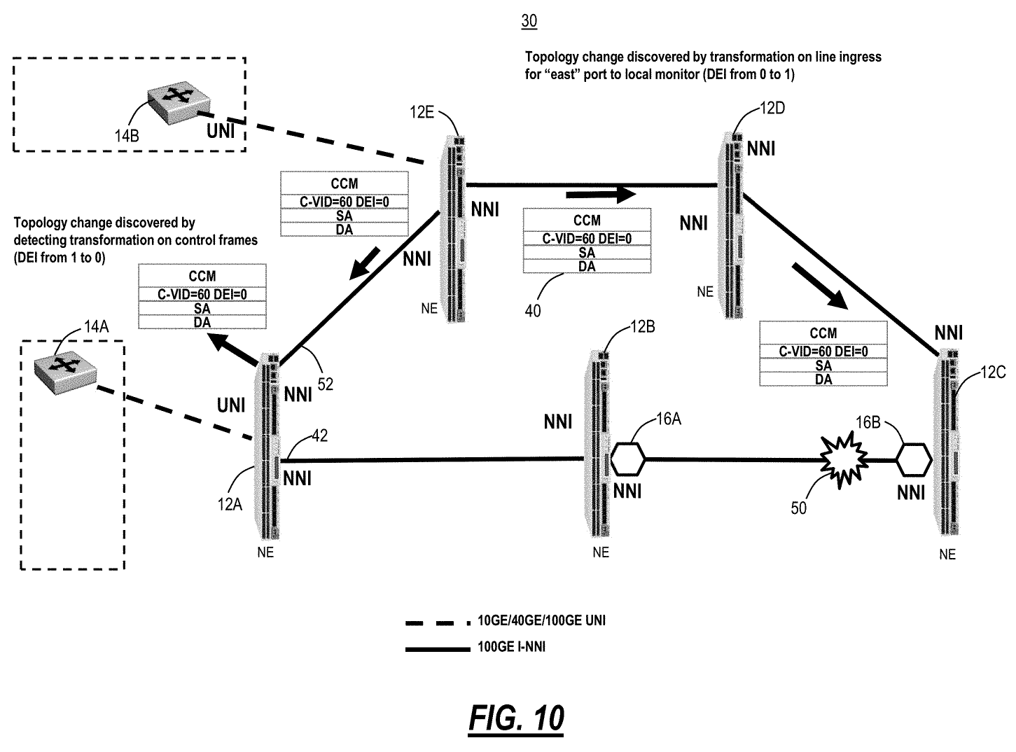

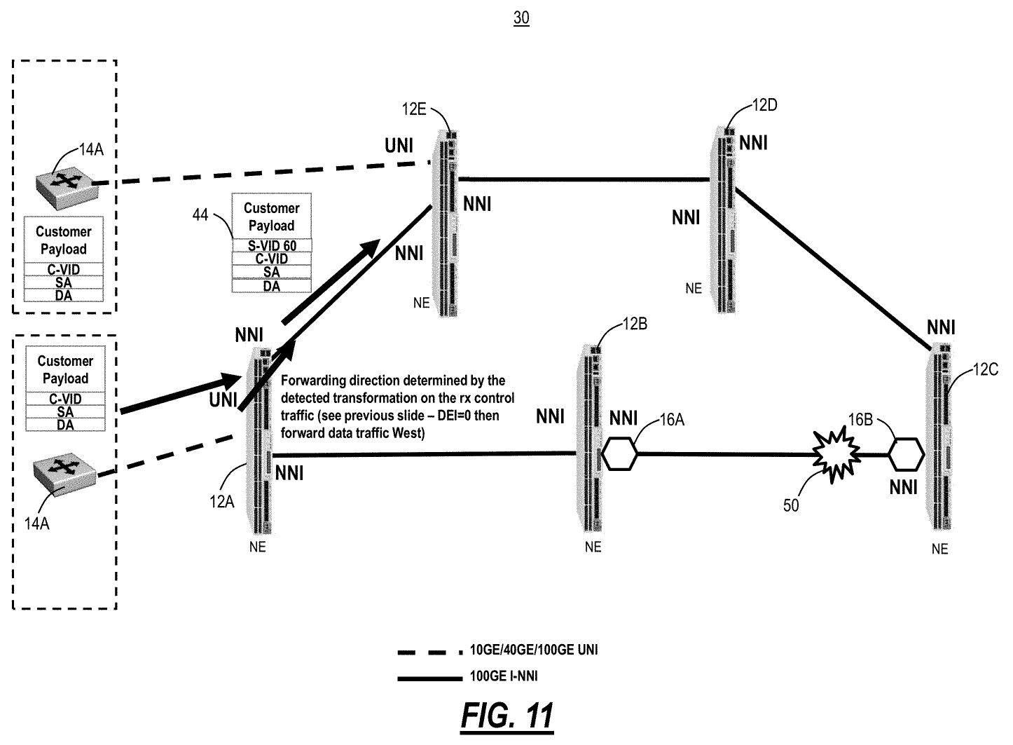

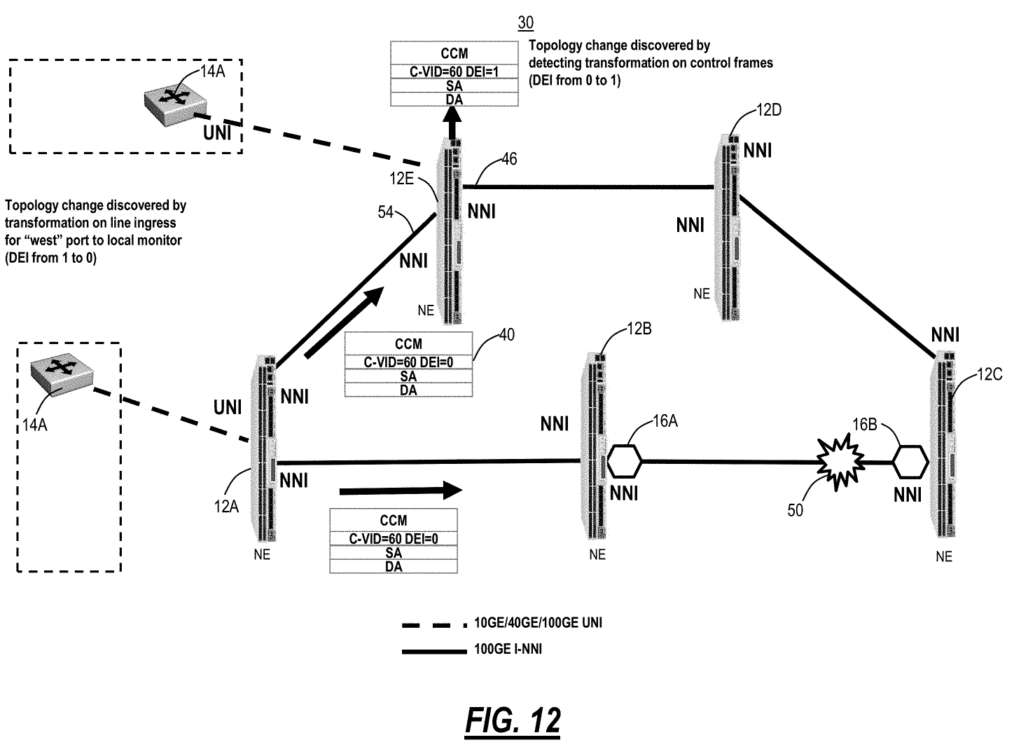

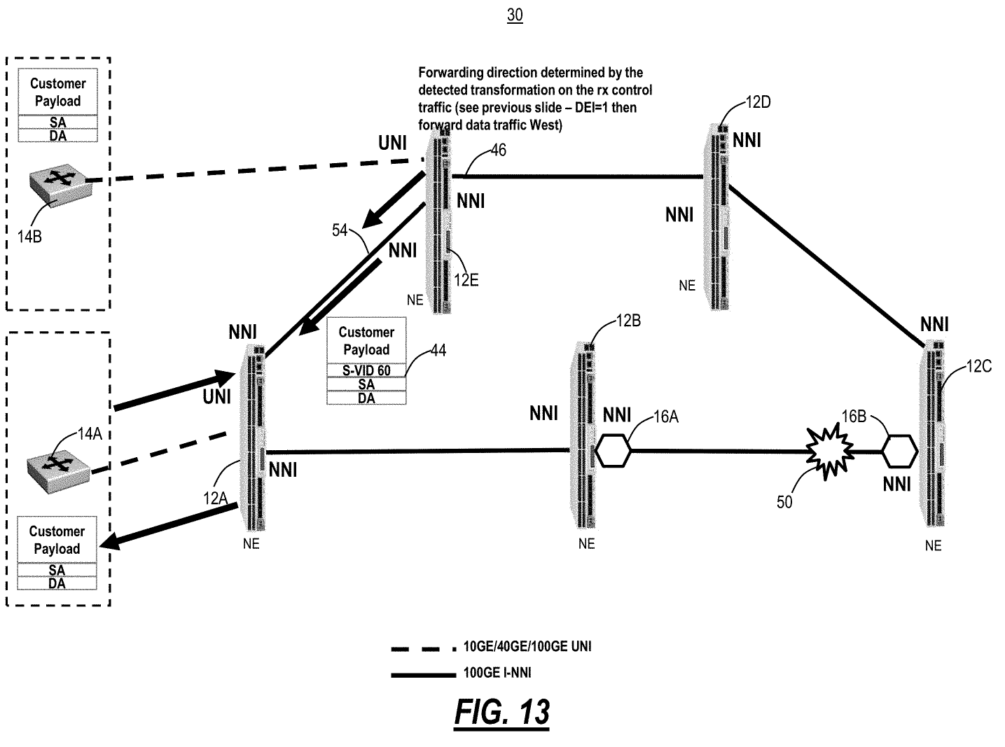

FIG. 10 is a network diagram of the network 30 illustrating a fault 50 between the network elements 12B, 12C and associated control traffic originating at the network element 12E. FIG. 11 is a network diagram of the network 30 illustrating associated data traffic from the network element 12A subsequent to the fault 50. FIG. 12 is a network diagram of the network 30 illustrating associated control traffic originating at the network element 12A subsequent to the fault 50. FIG. 13 is a network diagram of the network 30 illustrating associated data traffic from the network element 12E subsequent to the fault 50.

In FIG. 10, once the fault 50 is detected (e.g., based on the loss of the control frames 40), G.8032 installs ring blocks 16A, 16B adjacent to the fault 50 and removes the ring block 16.

FIG. 10 illustrates the control frames 40 originating at the network element 12E subsequent to the fault 50. With the ring block 16 removed, the network element 12A now receives the control frames 40 from the network element 12E on a West NNI port 52 and not on the East NNI port 42. Thus, the network element 12A can infer a topology change based on the transformations. That is, when the fault 50 (discontinuity) occurs, the ring protection algorithm in G.8032 alters the generic network forwarding and transformations can be used to discover the change automatically.

In FIG. 11, the data frames 44 are shown originating from the network element 12A from the switch 14A destined for the switch 14 B via the network element 12E subsequent to the fault 50. The forwarding direction can be changed from the East NNI port 42 to the West NNI port 52 based on the detected transformation change in FIG. 10.

In FIG. 12, the control frames 40 are illustrated originating at the network element 12A subsequent to the fault 50. Here, the control frames 40 are now received at the network element 12E on an East NNI port 54 instead of the West NNI port 46 based on detecting the DEI transformation change from DEI 0 to 1.

In FIG. 13, the data frames 44 are shown originating from the network element 12E from the switch 14B destined for the switch 14A via the network element 12A subsequent to the fault 50. The forwarding direction can be changed from the West NNI port 46 to the East NNI port 54 based on the detected transformation change in FIG. 12.

Thus, the multicast control frames 40 can be used to infer which forwarding direction to send the data frames 44 in a G.8032 ring instead of MAC flooding, learning, and flushing. This approach is significantly quicker and less complex. The transformations are one approach to quickly and efficiently determine where the control frames 40 are received from.

### Ethernet Forwarding Based on Inferred Topology—Reversion

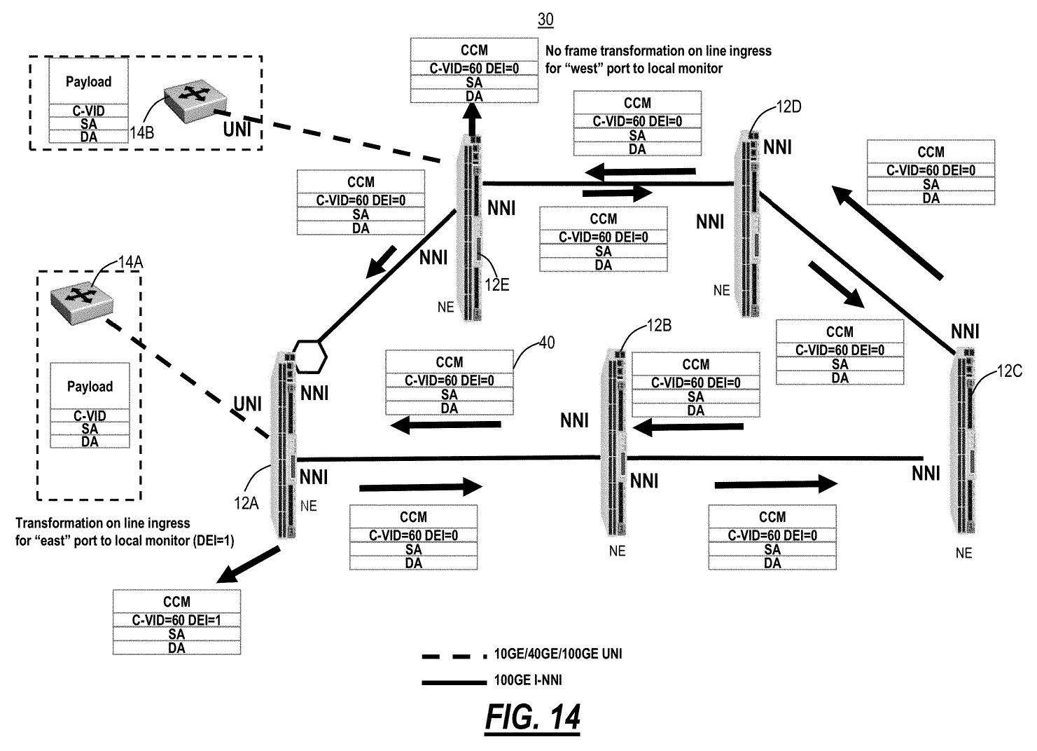

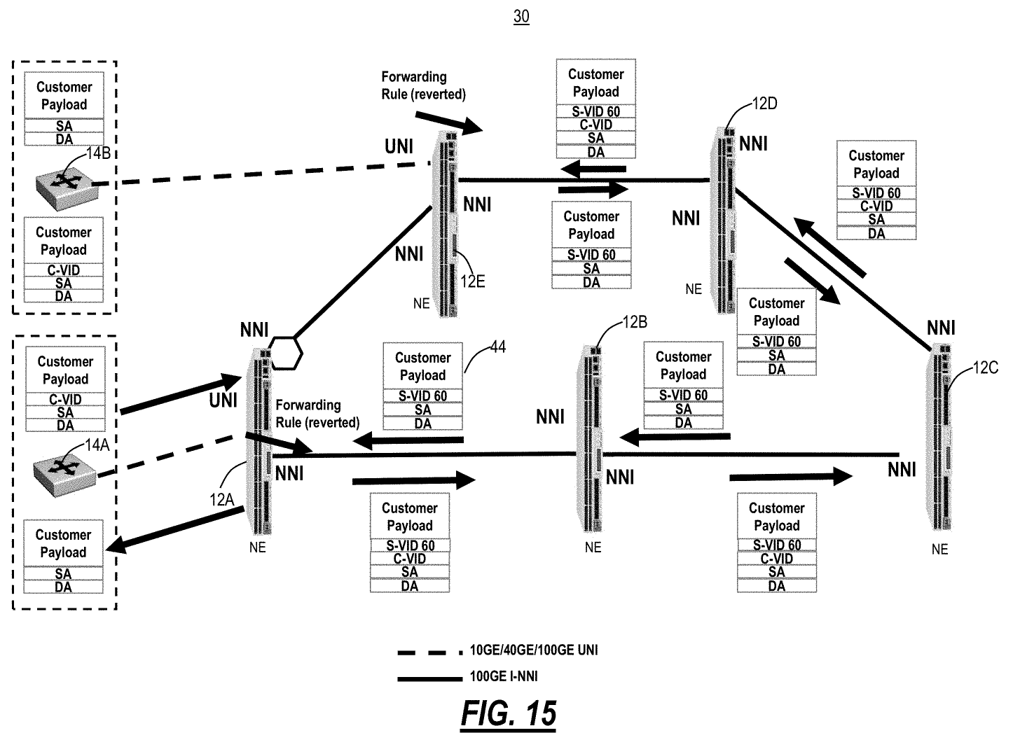

FIG. 14 is a network diagram of the network 30 and associated control traffic subsequent to the fault 50 being cleared. FIG. 15 is a network diagram of the network 30 and associated data traffic subsequent to the fault 50 being cleared. In FIGS. 14 and 15, the fault 50 is remedied/cleared. For example, if the fault 50 was a fiber cut, the fiber has been repaired/spliced. If the fault 50 was an equipment failure, the equipment has been replaced, etc. G.8032 removes the ring blocks 16A, 16B after detecting the fault 50 is remedied, and the control frames 40 in FIG. 14 show updated transformations to reflect the ring block 16 being reinstalled at the West NNI port 52 on the network element 12A. In this manner, the network elements 12A, 12E can detect changes in the control frames 40 based on the transformation and revert back to the original path with the data frames 44 in FIG. 15.

Thus, the network elements 12A, 12E (the terminal network elements) can continually monitor for the control frames 40 and any associated transformations. Upon detecting a change in the control frames 40, the network elements 12A, 12E can change the forwarding direction accordingly. This provides much faster traffic rerouting versus flooding, learning, and flushing.

### Ethernet Forwarding Based on Inferred Topology—Misconfiguration

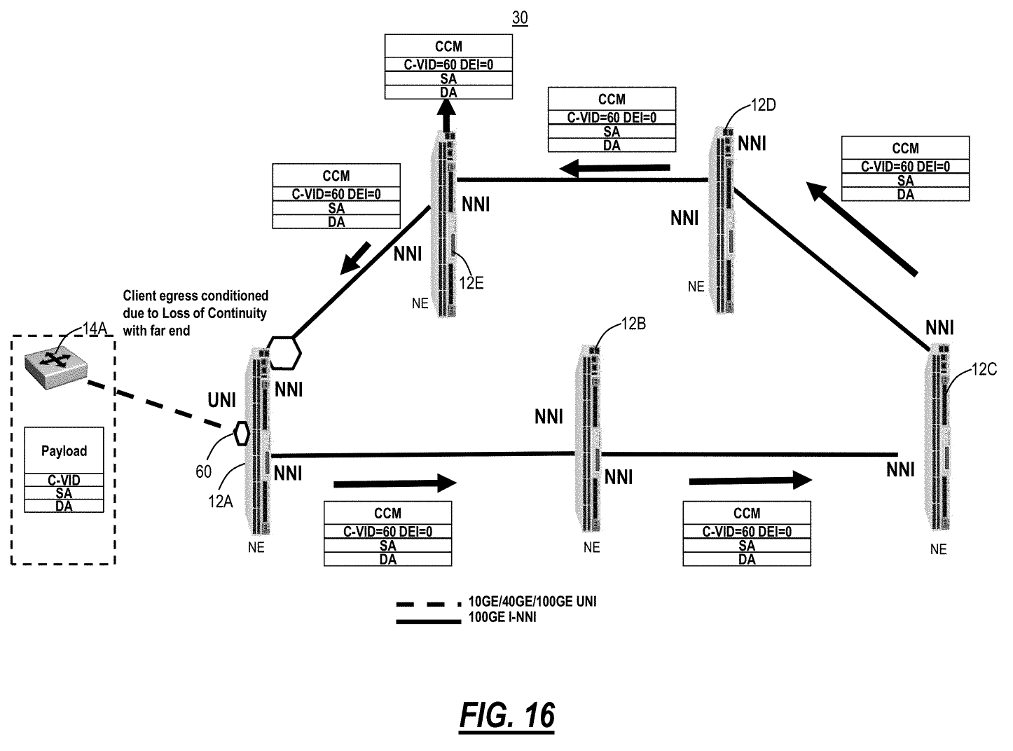

FIG. 16 is a network diagram of the network 30 in a misconfiguration scenario. Here, the network element 12E is misconfigured which is detected based on the lack of control frames 40 originating therefrom. Should a partial or misconfiguration be present in the network 30, a loss of control traffic from the “mate port” would occur, a client egress port 60 can be conditioned, and no customer traffic will flow into the network 30. No forwarding decisions required since traffic is “squelched” on “client” ingress by conditioning.

### 1+1 Ethernet Line Protection

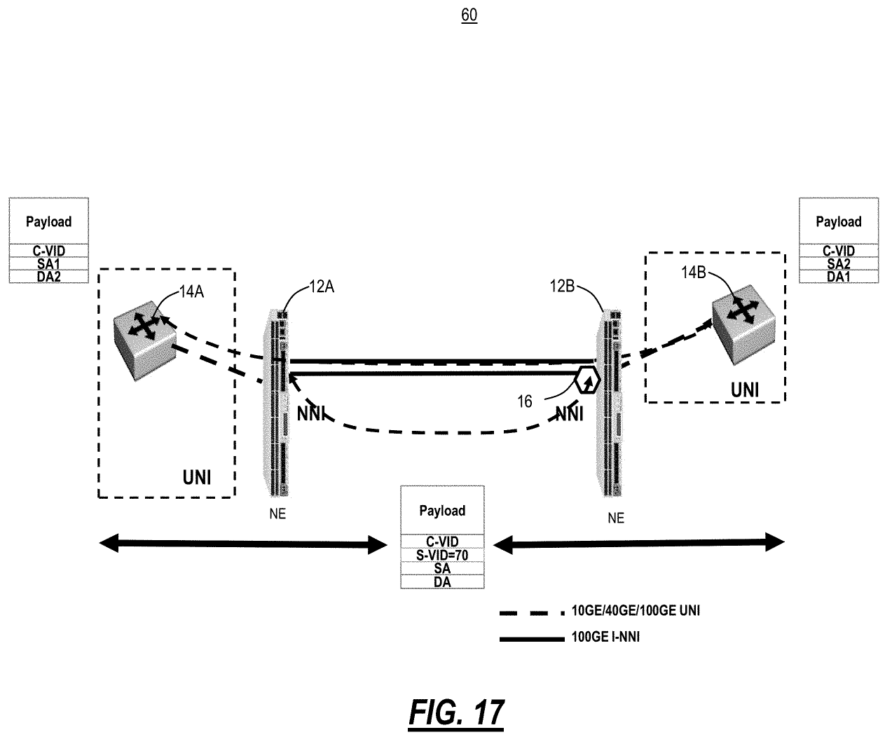

FIG. 17 is a network diagram of a network 60 illustrating 1+1 Ethernet Line Protection utilizing the systems and methods. Here, the network 60 includes network elements 12A, 12B in a point-to-point linear system using G.8032, e.g., a two-node G.8032 ring. There is a ring block 16 on one of the ports of the network element 12B. The use of the control frames to infer the topology can be used to form a 1+1 type protection scheme without relying on an Ethernet switches flooding, learning, and flushing performance.

### 1+1 Ethernet Line Protection

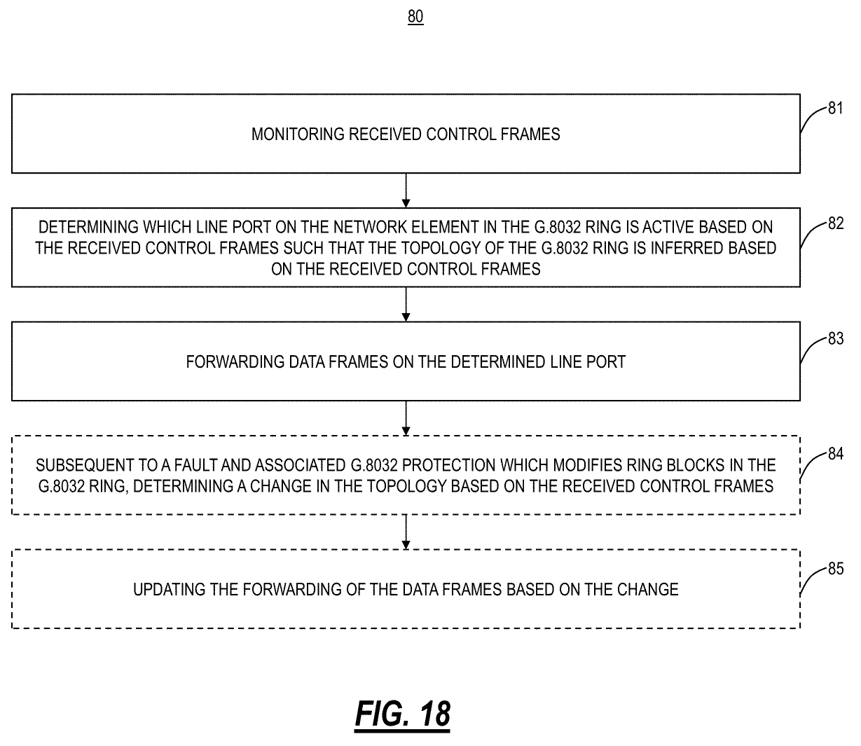

FIG. 18 is a flowchart of a process 80 for Ethernet forwarding based on inferring topology in a G.8032 ring via control frames. The process 80 can be implemented in the network element 12A, 12E. The process 80 includes monitoring received control frames (step 81); determining which line port on the network element in the G.8032 ring is active based on the received control frames such that the topology of the G.8032 ring is inferred based on the received control frames (step 82); and forwarding data frames on the determined line port (step 83). The process 80 can further include, subsequent to a fault and associated G.8032 protection which modifies ring blocks in the G.8032 ring, determining a change in the topology based on the received control frames (step 84); and updating the forwarding of the data frames based on the change (step 85).

The determining can be based on detecting transformations of the received control frames. The transformations can include adjustments to one or more of Priority Code Point (PCP) and Drop Eligible Indicator (DEI) values in the control frame. The transformations can include detection of a Virtual Local Area Network (VLAN) tag. The received control frames can be multicast by terminal network elements in the G.8032 ring and prevented from a loop in the G.8032 based on a ring block. The network element is configured to not perform Media Access Control (MAC) learning and flooding for forwarding decisions. The G.8032 ring provides Ethernet Ring Protection in conjunction with one of an Ethernet Private Line (EPL) service and an Ethernet Private Local Area Network (EPLAN) service.

### Network Element

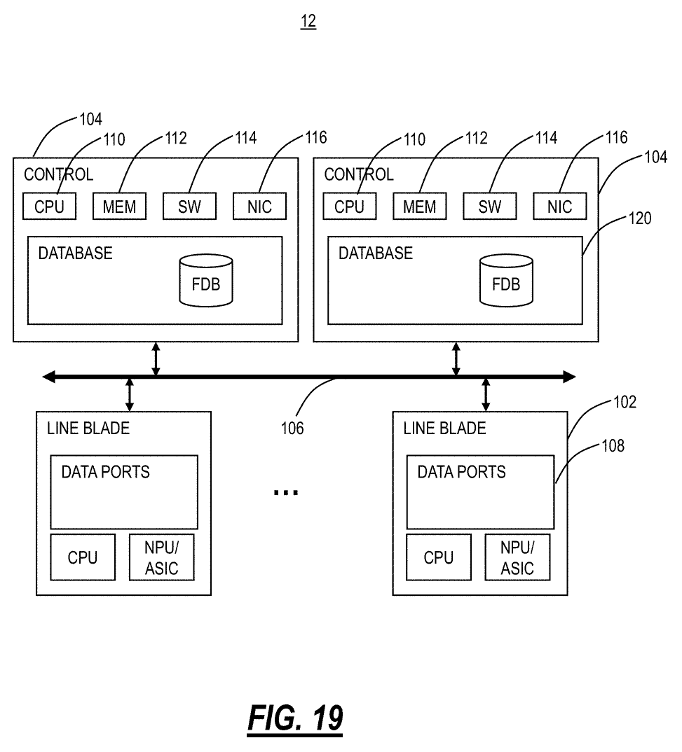

FIG. 19 is a block diagram of an example network element 12 for the systems and methods described herein. In this embodiment, the network element 12 is an Ethernet packet switch, but those of ordinary skill in the art will recognize the systems and methods described herein can operate with other types of network elements and other implementations, supporting Ethernet. In this embodiment, the network element 12 includes a plurality of blades 102, 104 interconnected via an interface 106. The blades 102, 104 are also known as line cards, line modules, circuit packs, pluggable modules, etc. and generally refer to components mounted on a chassis, shelf, etc. of a data switching device, i.e., the network element 12. Each of the blades 102, 104 can include numerous electronic devices and optical devices mounted on a circuit board along with various interconnects including interfaces to the chassis, shelf, etc. Those skilled in the art will recognize that the network element 12 is illustrated in an oversimplified manner and may include other components and functionality.

Two blades are illustrated with line blades 102 and control blades 104. The line blades 102 include data ports 108 such as a plurality of Ethernet ports. For example, the line blade 102 can include a plurality of physical ports disposed on an exterior of the blade 102 for receiving ingress/egress connections. Additionally, the line blades 102 can include switching components to form a switching fabric via the interface 106 between all of the data ports 108 allowing data traffic to be switched between the data ports 108 on the various line blades 102. The switching fabric is a combination of hardware, software, firmware, etc. that moves data coming into the network element 12 out by the correct port 108 to the next network element 12. “Switching fabric” includes switching units, or individual boxes, in a node; integrated circuits contained in the switching units; and programming that allows switching paths to be controlled. Note, the switching fabric can be distributed on the blades 102, 104, in a separate blade (not shown), or a combination thereof. The line blades 102 can include an Ethernet manager (i.e., a processor) and a Network Processor (NP)/Application Specific Integrated Circuit (ASIC).

The control blades 104 include a microprocessor 110, memory 112, software 114, and a network interface 116. Specifically, the microprocessor 110, the memory 112, and the software 114 can collectively control, configure, provision, monitor, etc. the network element 12. The network interface 116 may be utilized to communicate with an element manager, a network management system, etc. Additionally, the control blades 104 can include a database 120 that tracks and maintains provisioning, configuration, operational data and the like. In this embodiment, the network element 12 includes two control blades 104 which may operate in a redundant or protected configuration such as 1:1, 1+1, etc. In general, the control blades 104 maintain dynamic system information including packet forwarding databases, protocol state machines, and the operational status of the ports 108 within the network element 12.

Of note, the network element 12 is illustrated with a controller/blade architecture. However, those of ordinary skill in the art will recognize the line blades 102 and the control blades 104 can be combined in a single device or other hardware configurations.

In an embodiment, the network element 12 includes a plurality of ports 108 and switching circuitry configured to switch frames between the plurality of ports 108; and a controller 104 communicatively coupled to the plurality of ports 108 and the switching circuitry. The controller 104 is configured to monitor received control frames, determine which line port on the network element in the G.8032 ring is active based on the received control frames such that the topology of the G.8032 ring is inferred based on the received control frames, and cause the data frames to be forwarded on the determined line port.

The controller 104 can be further configured to determine a change in the topology based on the received control frames subsequent to a fault and associated G.8032 protection which modifies ring blocks in the G.8032 ring, cause the data frames to be forwarded based on the change. The controller 104 can detect transformations of the received control frames. The received control frames are multicast by terminal network elements in the G.8032 ring and prevented from a loop in the G.8032 based on a ring block.

In another embodiment, an apparatus configured for Ethernet forwarding based on inferring topology in a G.8032 ring via control frames, implemented in a network element, includes circuitry configured to monitor received control frames; circuitry configured to determine which line port on the network element in the G.8032 ring is active based on the received control frames such that the topology of the G.8032 ring is inferred based on the received control frames; and circuitry configured to forward data frames on the determined line port.

The apparatus can further include circuitry configured to determine a change in the topology based on the received control frames subsequent to a fault and associated G.8032 protection which modifies ring blocks in the G.8032 ring, wherein the circuitry configured to forward data frames is updated based on the change. The circuitry configured to determine can detect transformations of the received control frames. The transformations can include adjustments to one or more of Priority Code Point (PCP) and Drop Eligible Indicator (DEI) values in the control frame. The transformations can include detection of a Virtual Local Area Network (VLAN) tag.

The received control frames are multicast by terminal network elements in the G.8032 ring and prevented from a loop in the G.8032 based on a ring block. The network element is configured to not perform Media Access Control (MAC) learning and flooding for forwarding decisions. The G.8032 ring provides Ethernet Ring Protection in conjunction with one of an Ethernet Private Line (EPL) service and an Ethernet Private Local Area Network (EPLAN) service.

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

1. A method for Ethernet forwarding based on inferring topology in a G.8032 ring via control frames, implemented in a network element, the method comprising:
monitoring received control frames;
determining which line port on the network element in the G.8032 ring is active based on the received control frames such that the topology of the G.8032 ring is inferred based on detecting transformations of the received control frames; and
forwarding data frames on the determined line port.

2. The method of claim 1, further comprising:
subsequent to a fault and associated G.8032 protection which modifies ring blocks in the G.8032 ring, determining a change in the topology based on the received control frames; and
updating the forwarding of the data frames based on the change.

3. (canceled)

4. The method of claim 1, wherein the transformations comprise adjustments to one or more of Priority Code Point (PCP) and Drop Eligible Indicator (DEI) values in the control frame.

5. The method of claim 1, wherein the transformations comprise detection of a Virtual Local Area Network (VLAN) tag.

6. The method of claim 1, wherein the received control frames are multicast by terminal network elements in the G.8032 ring and prevented from a loop in the G.8032 based on a ring block.

7. The method of claim 1, wherein the network element is configured to not perform Media Access Control (MAC) learning and flooding for forwarding decisions.

8. The method of claim 1, wherein the G.8032 ring provides Ethernet Ring Protection in conjunction with one of an Ethernet Private Line (EPL) service and an Ethernet Private Local Area Network (EPLAN) service.

9. The method of claim 1, wherein the control frames are sent at an interval of 10 ms or less.

10. An apparatus configured for Ethernet forwarding based on inferring topology in a G.8032 ring via control frames, implemented in a network element, the apparatus comprising:
circuitry configured to monitor received control frames;
circuitry configured to determine which line port on the network element in the G.8032 ring is active based on the received control frames such that the topology of the G.8032 ring is inferred based on detection of transformations of the received control frames; and
circuitry configured to forward data frames on the determined line port.

11. The apparatus of claim 10, further comprising:
circuitry configured to determine a change in the topology based on the received control frames subsequent to a fault and associated G.8032 protection which modifies ring blocks in the G.8032 ring,
wherein the circuitry configured to forward data frames is updated based on the change.

12. (canceled)

13. The apparatus of claim 10, wherein the transformations comprise adjustments to one or more of Priority Code Point (PCP) and Drop Eligible Indicator (DEI) values in the control frame.

14. The apparatus of claim 10, wherein the transformations comprise detection of a Virtual Local Area Network (VLAN) tag.

15. The apparatus of claim 10, wherein the received control frames are multicast by terminal network elements in the G.8032 ring and prevented from a loop in the G.8032 based on a ring block.

16. The apparatus of claim 10, wherein the network element is configured to not perform Media Access Control (MAC) learning and flooding for forwarding decisions.

17. The apparatus of claim 10, wherein the G.8032 ring provides Ethernet Ring Protection in conjunction with one of an Ethernet Private Line (EPL) service and an Ethernet Private Local Area Network (EPLAN) service.

18. The apparatus of claim 10, wherein the control frames are sent at an interval of 10 ms or less.

19. A network element configured for Ethernet forwarding based on inferring topology in a G.8032 ring via control frames, the network element comprising:
a plurality of ports and switching circuitry configured to switch frames between the plurality of ports; and
a controller communicatively coupled to the plurality of ports and the switching circuitry, wherein the controller is configured to
monitor received control frames,
determine which line port on the network element in the G.8032 ring is active based on the received control frames such that the topology of the G.8032 ring is inferred based on detection of transformations of the received control frames, and
cause the data frames to be forwarded on the determined line port.

20. The network element of claim 19, wherein the controller is further configured to
determine a change in the topology based on the received control frames subsequent to a fault and associated G.8032 protection which modifies ring blocks in the G.8032 ring, and cause the data frames to be forwarded based on the change.
